(19) United States
(12) Patent Application Publication
(10) Pub. No.: US 2022/0056929 A1
(43) Pub. Date: Feb. 24, 2022

(54) FLUID PRESSURE CYLINDER

(71) Applicant: SMC CORPORATION, Chiyoda-ku (JP)

(72) Inventor: Ryosuke SATO, Tsukubamirai-shi (JP)

(73) Assignee: SMC CORPORATION, Chiyoda-ku (JP)

(21) Appl. No.: 17/275,360

(22) PCT Filed: Sep. 9, 2019
(86) PCT No.: PCT/JP2019/035383

§ 371 Date: Mar. 11, 2021

(30) Foreign Application Priority Data
Sep. 12, 2018 (JP) 2018-170625

(51) Int. Cl. F15B 15/20; F15B 15/14

(52) U.S. Cl. CPC F15B 15/20; F15B 15/1428

(57) ABSTRACT

When viewed in section, a cylinder hole in a fluid pressure cylinder has a polygonal shape including inner circumferential surfaces parallel to a plurality of surfaces constituting a body. A piston has a polygonal outer edge having a shape corresponding to the shape of the cylinder hole and partitions the cylinder hole into a head-side cylinder chamber and a rod-side cylinder chamber. The body is cut off so that a first side surface has a stepped shape, and a solenoid valve is disposed in a solenoid valve arrangement space formed by cutting off the body. The solenoid valve is disposed inside a virtual outer shape defined by most-protruding faces in the respective surfaces.

### TECHNICAL FIELD

The present invention relates to fluid pressure cylinders moving pistons based on supply and discharge of pressurized fluid.

### BACKGROUND ART

A known fluid pressure cylinder includes a cylinder tube with a cylinder hole, a piston accommodated in the cylinder hole to be movable, a piston rod secured to the piston, and an end plate connected to an end portion of the piston rod (see Japanese Laid-Open Patent Publication No. 09-303318). The fluid pressure cylinder moves the piston, the piston rod, and the end plate forward by pressurized fluid being supplied to a head-side cylinder chamber in the cylinder tube and discharged from a rod-side cylinder chamber in the cylinder tube. Conversely, the fluid pressure cylinder moves the piston, the piston rod, and the end plate backward by pressurized fluid being supplied to the rod-side cylinder chamber and discharged from the head-side cylinder chamber.

### SUMMARY OF INVENTION

The fluid pressure cylinder of this type switches between supply and discharge of pressurized fluid to and from the rod-side cylinder chamber or the head-side cylinder chamber based on the operation of a solenoid valve connected to the fluid pressure cylinder during actual use. For example, in the fluid pressure cylinder disclosed in Japanese Laid-Open Patent Publication No. 09-303318, a solenoid valve and a sub-base configured to switch flow channels for pressurized fluid and to which the solenoid valve is connected are attached to a surface (side surface) of the cylinder tube.

Since the solenoid valve and other elements are attached to the surface of the cylinder tube, the size of the fluid pressure cylinder becomes larger during actual use compared with the size when the fluid pressure cylinder is provided as a product. Thus, users may have difficulties in securing an installation space for the fluid pressure cylinder while taking into consideration the positional relationship with other devices. Moreover, many hours are required to attach the solenoid valve and other elements to the fluid pressure cylinder.

The present invention has been devised taking into consideration the aforementioned problems, and has the object of providing a fluid pressure cylinder capable of achieving significant space-saving and improved usability during use with a simple structure.

To achieve the above-described object, a fluid pressure cylinder according to an aspect of the present invention includes a body having a rectangular parallelepiped shape with a cylinder hole, a piston movably accommodated in the cylinder hole, and a piston rod secured to the piston. When viewed in section orthogonal to an extension direction of the cylinder hole, the cylinder hole has a polygonal shape including inner circumferential surfaces parallel to a plurality of surfaces constituting the body. The piston has a polygonal outer edge having a shape corresponding to the shape of the cylinder hole accommodating the piston and partitions the cylinder hole into a head-side cylinder chamber and a rod-side cylinder chamber. The body is cut off so that one surface of the plurality of surfaces constituting the body has a stepped shape, and a solenoid valve configured to switch between supply of pressurized fluid to the head-side cylinder chamber or the rod-side cylinder chamber and discharge of the pressurized fluid from the head-side cylinder chamber or the rod-side cylinder chamber is disposed in a space formed by cutting off the body. The solenoid valve is disposed inside a virtual outer shape defined by most-protruding faces in the respective surfaces.

The fluid pressure cylinder includes the solenoid valve for switching between supply and discharge of pressurized fluid to and from the head-side cylinder chamber or the rod-side cylinder chamber. Thus, the solenoid valve is not required to be added separately for actual use of the fluid pressure cylinder. Moreover, since the cylinder hole and the outer edge of the piston have polygonal shapes when viewed in section, the body can be reduced in size while a sufficient area of the piston, which is pushed by pressurized fluid, is ensured compared with the case of a cylinder hole and a piston that have circular shapes when viewed in section. In addition, since the solenoid valve is disposed inside the virtual outer shape of the body, the fluid pressure cylinder does not increase in size as an entire system during use, allowing users to, for example, carry out design for installation in a preferred manner. That is, the fluid pressure cylinder can achieve significant space-saving and improved usability during use with a simple structure.

The above and other objects features and advantages of the present invention will become more apparent from the following description when taken in conjunction with the accompanying drawings in which a preferred embodiment of the present invention is shown by way of illustrative example.

### BRIEF DESCRIPTION OF DRAWINGS

FIG. 1 is a perspective view of the entire structure of a fluid pressure cylinder according to an embodiment of the present invention;

FIG. 2 is a view of the fluid pressure cylinder as viewed from a base end side;

FIG. 3 is a cross-sectional view taken along line III-III in FIG. 2;

FIG. 4 is a cross-sectional view taken along line IV-IV in FIG. 1;

FIG. 5 is a cross-sectional view taken along line V-V in FIG. 1;

FIG. 6 is a partial sectional view illustrating a solenoid valve and a structure allowing pressurized fluid to flow into the solenoid valve;

FIG. 7A is an explanatory view illustrating flow of pressurized fluid when a spool is disposed at a first position, and FIG. 7B is an explanatory view illustrating flow of the pressurized fluid when the spool is disposed at a second position; and

FIG. 8 is a perspective view of the entire structure of a fluid pressure cylinder according to a modification.

### DESCRIPTION OF EMBODIMENTS

A preferred embodiment according to the present invention will be described in detail below with reference to the accompanying drawings.

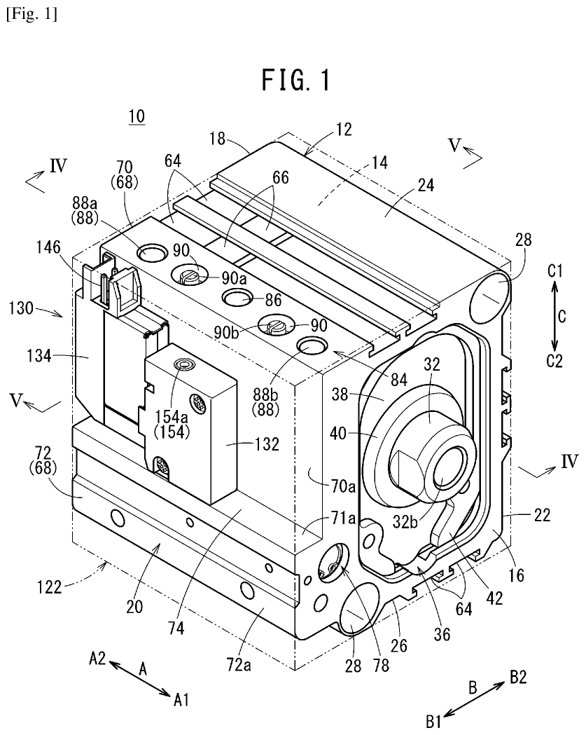

As illustrated in FIG. 1, a fluid pressure cylinder 10 according to an embodiment of the present invention includes a body 12 containing therein a cylinder hole 14. In the description below, based on arrows illustrated in FIG. 1, a direction toward the distal end and toward the base end of the body 12 is also referred to as a direction of an arrow A, the width direction of the body 12 is also referred to as a direction of an arrow B, and the thickness direction of the body 12 is also referred to as a direction of an arrow C.

The body 12 is a rectangular parallelepiped having a plurality of surfaces, that is, the distal end surface 16 located on a side at which an arrow A1 is pointing, the base end surface 18 located on a side at which an arrow A2 is pointing, a first side surface 20 located on a side at which an arrow B1 is pointing, a second side surface 22 located on a side at which an arrow B2 is pointing, a third side surface 24 located on a side at which an arrow C1 is pointing, and a fourth side surface 26 located on a side at which an arrow C2 is pointing.

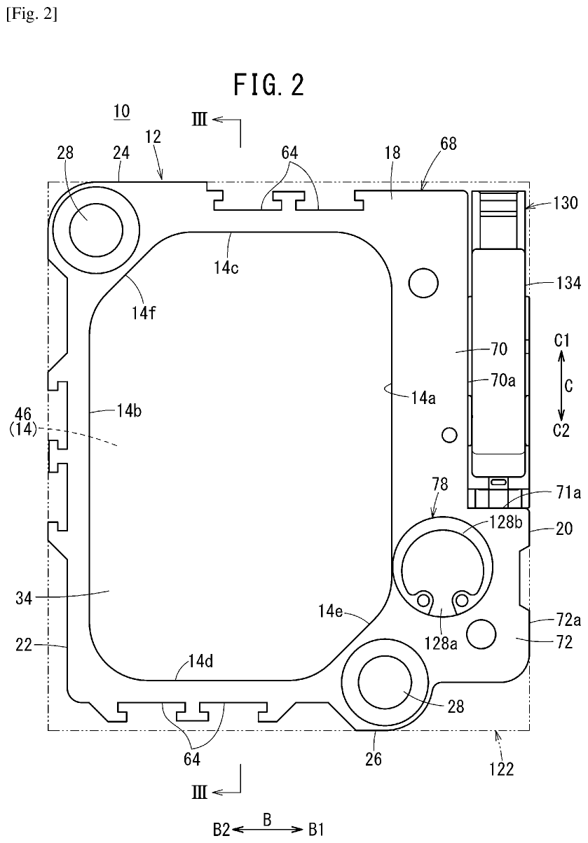

As illustrated in FIGS. 1 and 2, the body 12 has a plurality of (two in FIG. 1) fastener holes 28 for securing the fluid pressure cylinder 10 to a chosen object (installation target). The two fastener holes 28 are arranged at mutually diagonal positions adjacent to two corners of the distal end surface 16 and the base end surface 18. The fastener holes 28 penetrate through the body 12 in the direction of the arrow A. The fastener holes 28 may have a female thread portion in order to screw the fluid pressure cylinder 10 to the installation target.

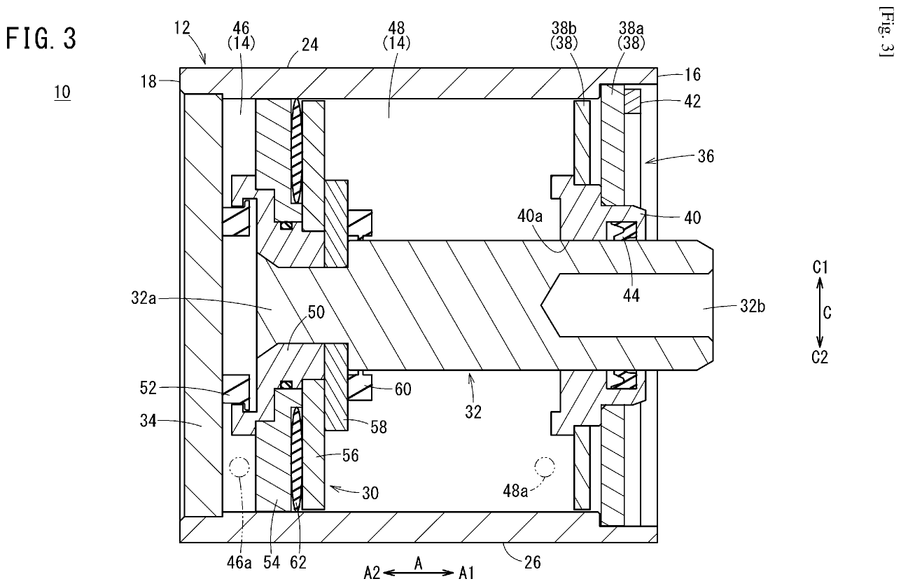

The cylinder hole 14 of the body 12 extends in the direction of the arrow A to penetrate through the distal end surface 16 and the base end surface 18. More specifically, the body 12 has a tubular shape (cylinder tube) surrounding the cylinder hole 14. As illustrated in FIG. 3, a piston 30 and a piston rod 32 secured to the piston 30 are displaceably accommodated in the cylinder hole 14.

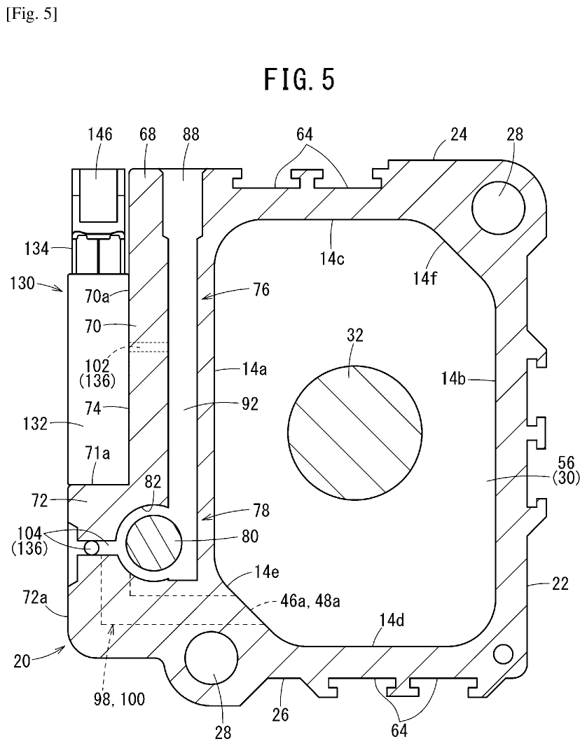

When viewed in section orthogonal to the extension direction of the cylinder hole 14, the cylinder hole 14 has a polygonal shape with sides parallel to the plurality of surfaces (first, second, third, and fourth side surfaces 20, 22, 24, and 26) constituting the body 12 (see also FIG. 5). In other words, the inner circumferential surface of the body 12 defining the cylinder hole 14 has a hexagonal shape with rounded corners and which is flattened in the direction of the arrow B (lateral direction or short-side direction).

More specifically, as illustrated in FIGS. 2 and 5, the inner circumferential surface of the body 12 includes a first inner circumferential surface 14a parallel to and adjacent to the first side surface 20, a second inner circumferential surface 14b parallel to and adjacent to the second side surface 22, a third inner circumferential surface 14c parallel to and adjacent to the third side surface 24, and a fourth inner circumferential surface 14d parallel to and adjacent to the fourth side surface 26. The inner circumferential surface further includes a fifth inner circumferential surface 14e inclined between the first inner circumferential surface 14a and the fourth inner circumferential surface 14d and a sixth inner circumferential surface 14f inclined between the second inner circumferential surface 14b and the third inner circumferential surface 14c. The first inner circumferential surface 14a and the second inner circumferential surface 14b face each other in parallel to each other, and the third inner circumferential surface 14c and the fourth inner circumferential surface 14d face each other in parallel to each other. The fifth inner circumferential surface 14e and the sixth inner circumferential surface 14f face each other in parallel to each other, and have shorter lengths than the first to fourth inner circumferential surfaces 14a to 14d when viewed in section. Furthermore, the above-described fastener holes 28 are arranged at positions adjacent to and outside the fifth and sixth inner circumferential surfaces 14e and 14f. The first to sixth inner circumferential surfaces 14a to 14f extend parallel to each other (without changing the cross-sectional shape) in the axial direction of the body 12 (direction of the arrow A).

As illustrated in FIGS. 2 and 3, the body 12 includes a head cover 34 on an inner circumferential surface thereof that is closer to the base end of the cylinder hole 14. The head cover 34 airtightly closes the base end of the cylinder hole 14. Thus, the outer edge of the head cover 34 has a shape corresponding to the cross-sectional shape (hexagon) of the cylinder hole 14.

The body 12 further includes a rod guiding structure 36 on an inner circumferential surface thereof that is closer to the distal end of the cylinder hole 14. The rod guiding structure 36 prevents the piston 30 and the piston rod 32 from coming off and has a function of guiding the displacement of the piston rod 32. For example, the rod guiding structure 36 includes supporting members 38 (a first supporting member 38a and a second supporting member 38b), a rod cover 40, and a snap ring 42.

The first supporting member 38a has a plate shape with a predetermined thickness in the direction of the arrow A, and is locked with the inner circumferential surface of the body 12 defining the cylinder hole 14. The second supporting member 38b has a plate shape with a thickness less than the thickness of the first supporting member 38a, and is disposed on the inner circumferential surface of the body 12 inside (on the side at which the arrow A2 is pointing) the first supporting member 38a in the cylinder hole 14. The outer edges of the first and second supporting members 38a and 38b have a shape corresponding to the hexagonal shape of the cylinder hole 14. The first and second supporting members 38a and 38b have respective circular cover holes formed in the central parts thereof, and the rod cover 40 is secured to the cover holes.

The rod cover 40 is a ring-shaped member having, formed therein, a through-hole 40a through which the piston rod 32 passes. When viewed in section along the axial direction of the body 12 (side cross-section), the diameter of the outer circumferential surface of the rod cover 40 decreases stepwise (in three stages) toward the distal end of the body 12 (hereinafter referred to as “distal end” unless otherwise specified). The rod cover 40 is secured to the supporting members 38 such that the smallest-diameter outer circumferential surface is supported by the first supporting member 38a, that the second-smallest-diameter outer circumferential surface is supported by the second supporting member 38b, and that the distal end surface of an outer circumferential part with the largest diameter is caught by the base end surface of the second supporting member 38b.

The through-hole 40a of the rod cover 40 allows part of the piston rod 32 to be exposed to the outside of the body 12 (toward the distal end). A seal member 44 is disposed on the inner circumferential surface of the rod cover 40 defining the through-hole 40a. The seal member 44 is in airtight contact with the outer circumferential surface of the piston rod 32. That is, the rod cover 40 is capable of guiding the movement of the piston rod 32 while restricting outflow of pressurized fluid inside the cylinder hole 14. The snap ring 42 is locked with the inner circumferential surface of the body 12 to prevent the rod guiding structure 36 from coming off.

The piston 30 disposed inside the cylinder hole 14 partitions the space of the cylinder hole 14 into two spaces. More specifically, the space on the base end side of the piston 30 is defined as a head-side cylinder chamber 46, and the space on the distal end side of the piston 30 is defined as a rod-side cylinder chamber 48.

The head-side cylinder chamber 46 is enclosed by the piston 30, the distal end surface of the head cover 34, and the inner circumferential surface of the body 12. A head-side opening 46a through which pressurized fluid flows in and out is formed in the fifth inner circumferential surface 14e of the head-side cylinder chamber 46. The rod-side cylinder chamber 48 is enclosed by the piston 30, the base end surface of the rod guiding structure 36, and the inner circumferential surface of the body 12. A rod-side opening 48a through which pressurized fluid flows in and out is formed in the fifth inner circumferential surface 14e of the rod-side cylinder chamber 48.

The piston 30 is slidable on the inner circumferential surface of the body 12 defining the cylinder hole 14 while airtightly isolating the head-side cylinder chamber 46 and the rod-side cylinder chamber 48 from each other. The piston 30 is configured as a structure including a plurality of members combined. More specifically, the piston 30 includes an attachment member 50 directly attached to the piston rod 32, a base-end-side damper 52 secured to a base end side of the attachment member 50, a wear ring 54 secured to the outer circumferential surface of the attachment member 50, a plate ring 56 disposed on the distal end side of the wear ring 54, a spacer 58 secured to the piston rod 32 on the distal end side of the attachment member 50, and a distal-end-side damper 60 secured to the piston rod 32 on the distal end side of the spacer 58.

The attachment member 50 has a disk shape with a predetermined thickness and slightly protrudes from the base end of the piston rod 32 toward the base end of the body 12 (hereinafter referred to as “base end” unless otherwise specified) when being secured to the base end of the piston rod 32. The inner circumferential surface of the attachment member 50 is partially formed into a hook shape in order to catch and lock the ring-shaped base-end-side damper 52.

The diameter of the outer circumferential surface of the attachment member 50 increases stepwise (in four stages) toward the base end. The attachment member 50 is configured such that the plate ring 56 is secured to the smallest-diameter outer circumferential surface at the most distal end side, that the wear ring 54 is secured to the second- and third-smallest-diameter outer circumferential surfaces, and that the distal end surface of an outer circumferential part with the largest diameter is caught by the base end surface of the wear ring 54.

The wear ring 54 has a sufficient thickness in the direction of the arrow A, and the outer edge (outer circumferential surface) thereof has a shape corresponding to the polygonal shape (hexagonal shape) of the cylinder hole 14 when viewed in section. The wear ring 54 contains a magnet (not illustrated) in the interior of the wear ring near the outer circumferential surface. Moreover, a piston packing 62 is held between the wear ring 54 and the plate ring 56. The piston packing 62 is in contact with the inner circumferential surface of the body 12 defining the cylinder hole 14 and thereby airtightly separates the head-side cylinder chamber 46 and the rod-side cylinder chamber 48 from each other.

Moreover, the magnet provided inside the wear ring 54 is a member for allowing detection sensors 66 (described below) to detect the position of the piston 30. Furthermore, when the piston 30 moves toward the distal end, the distal-end-side damper 60 comes into contact with the base end surface of the rod cover 40 at a stroke end to thereby reduce the impact at the time of movement.

On the other hand, the piston rod 32 is a sold cylindrical body extending along the axis of the cylinder hole 14 (direction of the arrow A) to a predetermined length (greater than the total length of the cylinder hole 14). The piston rod 32 includes an attachment part 32a at a base end portion. The diameter of the attachment part 32a is less than the diameter of the extending part of the piston rod 32. The attachment member 50 of the piston 30 and the spacer 58 are attached to the attachment part 32a.

The piston rod 32 protrudes from the body 12 in the distal end direction, i.e., the direction of the arrow A1, through the through-hole 40a of the rod cover 40 even when the piston 30 is disposed at the base end position inside the cylinder hole 14. A recessed part 32b is bored in a distal end portion of the piston rod 32 from the distal end surface of the piston rod 32 toward the base end to a predetermined depth. A plate or the like (not illustrated) is attached to the recessed part 32b during use of the fluid pressure cylinder 10. This enables the fluid pressure cylinder 10 to move a workpiece (not illustrated) disposed on the plate by moving the piston rod 32.

As illustrated in FIGS. 1 and 2, the fluid pressure cylinder 10 includes a pair of sensor attachment grooves 64 in each of the third and fourth side surfaces 24 and 26 of the body 12. The sensor attachment grooves 64 are flat, shallow recesses in the third and fourth side surfaces 24 and 26 and linearly extend in the axial direction (direction of the arrow A). The sensor attachment grooves 64 accommodate therein the respective detection sensors 66 for detecting the moving position of the piston 30 (magnet).

Furthermore, in the fluid pressure cylinder 10, a wall of the body 12 defining the first side surface 20 is slightly thicker than the other walls of the body 12 defining the other side surfaces (second, third, and fourth side surfaces 22, 24, and 26). The wall defining the first side surface 20 (hereinafter referred to as “structural wall 68”) is provided with a mechanism for supplying and discharging pressurized fluid to and from the head-side cylinder chamber 46 and the rod-side cylinder chamber 48 in the cylinder hole 14.

Specifically, the structural wall 68 includes a first wall portion 70 with a first thickness with respect to the cylinder hole 14 (first inner circumferential surface 14a) and a second wall portion 72 with a second thickness greater than the first thickness with respect to the cylinder hole 14. The second wall portion 72 is formed so as to be continuous to one side of the first side surface 20 on the side at which the arrow C2 is pointing, and is connected to the entire one side in the direction of the arrow A (in the extension direction of the one side). That is, the first side surface 20 is formed into a stepped shape including a first surface 70a of the first wall portion 70 and a second surface 72a of the second wall portion 72, which are arranged in the direction of the arrow C. An intermediate surface 71a (side surface of the second wall portion 72) is formed between the first surface 70a and the second surface 72a. A cut-off space in the structural wall 68 (space in the stepped part) is configured as a solenoid valve arrangement space 74 in which a solenoid valve 130 (described below) is disposed.

As illustrated in FIGS. 1, 4, and 5, the structural wall 68 contains therein channels (flow channels) 76 through which pressurized fluid flows and a channel selector 78 configured to switch the channels 76. The channel selector 78 includes a spool 80 configured to be displaced under operation of the solenoid valve 130, and a spool accommodation space 82 in which the spool 80 is movably accommodated and with which the channels 76 communicate.

A port group 84 communicating with the channels 76 is formed in the third side surface 24 of the body 12 including a side surface of the structural wall 68 (first wall portion 70). The port group 84 includes a supply port 86 for supplying pressurized fluid to the channels 76, two discharge ports 88 through which the pressurized fluid is discharged from the channels 76, and two controller ports 90. More specifically, the third side surface 24 has the supply port 86 in a middle part in the direction of the arrow A, the two controller ports 90 disposed adjacent to the supply port 86 such that the supply port 86 is sandwiched between the controller ports 90, and the two discharge ports 88 disposed such that the two controller ports 90 are sandwiched between the discharge ports 88. The ports are approximately aligned in the direction of the arrow A of the body 12.

A joint (not illustrated) is inserted and secured to the supply port 86 during use of the fluid pressure cylinder 10. The joint is connected to a pressurized fluid supply device 200 to allow pressurized fluid supplied from the pressurized fluid supply device 200 to flow into the supply port 86. The two discharge ports 88 includes a head-side discharge port 88a for discharging the pressurized fluid inside the head-side cylinder chamber 46 into the atmosphere and a rod-side discharge port 88b for discharging the pressurized fluid inside the rod-side cylinder chamber 48 into the atmosphere. Silencers (not illustrated) may be installed in the discharge ports 88 to reduce the discharge noise of the pressurized fluid.

The channels 76 are configured to cause pressurized fluid to flow between the port group 84 and the head-side cylinder chamber 46 and between the port group 84 and the rod-side cylinder chamber 48 via the spool accommodation space 82. To achieve this, the channels 76 include, between the port group 84 and the spool accommodation space 82, a supply channel 92 connecting the supply port 86 and the spool accommodation space 82, a head-side discharge channel 94 connecting the head-side discharge port 88a and the spool accommodation space 82, and a rod-side discharge channel 96 connecting the rod-side discharge port 88b and the spool accommodation space 82.

The supply channel 92 linearly extends from the supply port 86 in the third side surface 24 in the direction of the arrow C2. The head-side discharge channel 94 linearly extends from the spool accommodation space 82 in the direction of the arrow C1, bends by 90° in the direction of the arrow A2 at a first intermediate position 94a on the side at which the arrow C1 is pointing, and bends by 90° in the direction of the arrow C1 at a second intermediate position 94b adjacent to the first intermediate position 94a to communicate with the head-side discharge port 88a. One of the controller ports 90 is located at the first intermediate position 94a in the head-side discharge channel 94, and a head-side speed controller 90a is disposed therein. The rod-side discharge channel 96 linearly extends from the spool accommodation space 82 in the direction of the arrow C1, bends by 90° in the direction of the arrow A1 at a first intermediate position 96a on the side at which the arrow C1 is pointing, and bends in the direction of the arrow C1 at a second intermediate position 96b adjacent to the first intermediate position 96a to communicate with the rod-side discharge port 88b. The other controller port 90 is located at the first intermediate position 96a in the rod-side discharge channel 96, and a rod-side speed controller 90b is disposed therein.

The channels 76 further include a head-side communication channel 98 disposed between the spool accommodation space 82 and the head-side cylinder chamber 46, and a rod-side communication channel 100 disposed between the spool accommodation space 82 and the rod-side cylinder chamber 48. The head-side communication channel 98 and the rod-side communication channel 100 do not communicate with each other.

The head-side communication channel 98 communicates with the inner circumferential surface of the spool accommodation space 82 on the side at which the arrow B1 is pointing, and extends a short distance from the spool accommodation space 82 in the direction of the arrow C2. The head-side communication channel 98 then bends by 90° in the direction of the arrow A2 at a first curve point 98a and bends by 90° in the direction of the arrow B2 at a subsequent second curve point 98b to communicate with the head-side opening 46a of the head-side cylinder chamber 46.

Similarly, the rod-side communication channel 100 communicates with the inner circumferential surface of the spool accommodation space 82 on the side at which the arrow B1 is pointing, and extends a short distance from the spool accommodation space 82 in the direction of the arrow C2. The rod-side communication channel 100 then bends by 90° in the direction of the arrow A1 at a first curve point 100a and bends by 90° in the direction of the arrow B2 at a subsequent second curve point 100b to communicate with the rod-side opening 48a of the rod-side cylinder chamber 48.

The channels 76 further include a first branch channel 102 (pilot channel) at an intermediate position in the supply channel 92 to allow pressurized fluid to flow therethrough toward the first side surface 20 to which the solenoid valve 130 is attached. The first branch channel 102 communicates with the inside of the solenoid valve 130 through an opening in the first side surface 20. Moreover, a second branch channel 104 communicating with the supply channel 92 at all times is connected to the spool accommodation space 82 at the middle position in the axial direction where the supply channel 92 communicates with the spool accommodation space 82. The second branch channel 104 extends in the direction of the arrow A1 inside the second wall portion 72 at a position away from the spool accommodation space 82 in the direction of the arrow B1, and the second branch channel communicates with a first pressure chamber 112 formed on the distal end side of the spool accommodation space 82.

The above-described channels 76 are formed by boring holes in the body 12 from the surfaces to the inside during production of the body 12. This leaves forming channels 106 inside the body 12. The forming channels 106 communicate with the channels 76, but pressurized fluid does not flow in the forming channels 106. Openings of the forming channels 106 in the surfaces of the body 12 except for the port group 84 are blocked up by steel balls 108 (plugs) being inserted into the openings to prevent pressurized fluid from flowing out of the body 12 from the channels 76.

The spool accommodation space 82 in the structural wall 68 has a long, thin hollow shape extending in the direction of the arrow A, and the above-described channels 76 are connected to the spool accommodation space 82 at appropriately chosen positions. More specifically, the head-side discharge channel 94, the head-side communication channel 98, the supply channel 92, the rod-side communication channel 100, and the rod-side discharge channel 96 communicate with the spool accommodation space 82 in this order from the base end (on the side at which the arrow A2 is pointing) to the distal end (on the side at which the arrow A1 is pointing). The spool accommodation space 82 has a larger diameter at positions where the channels 76 are connected and has a smaller diameter at the other positions. That is, the spool accommodation space 82 includes a plurality of inward projections 110 protruding radially inward from the inner circumferential surface of the body 12.

In addition to the first pressure chamber 112 on the distal end side, the spool accommodation space 82 further includes a second pressure chamber 114 located on the base end side. The first pressure chamber 112 is airtightly closed by a restricting member 116 restricting the movement of the spool 80 toward the distal end. On the other hand, the second pressure chamber 114 is defined by a solenoid valve piston portion 118 configured to be displaced under the action of the solenoid valve 130. The solenoid valve piston portion 118 will be described later.

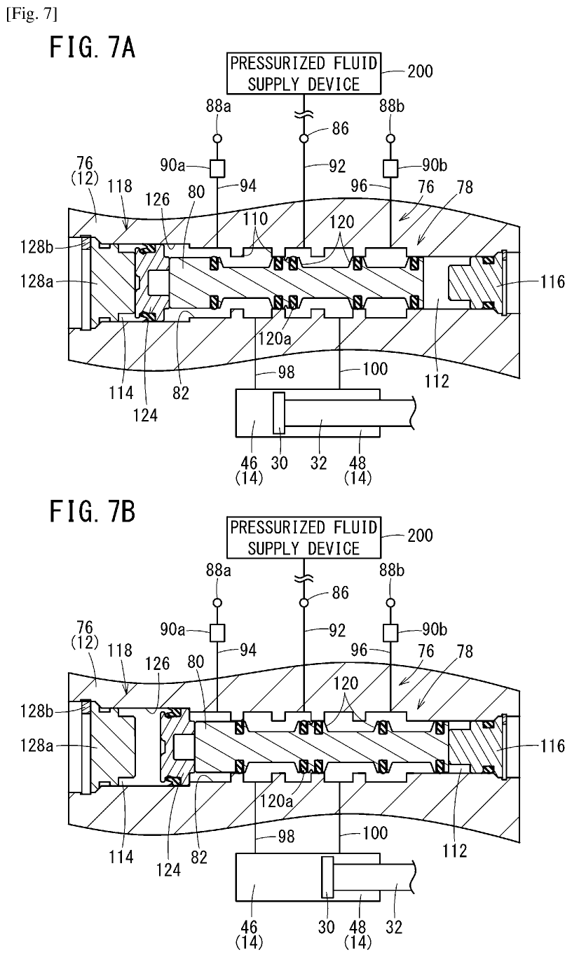

The spool 80 is a solid rod including a plurality of annular projections 120 protruding radially outward from the outer circumferential surface, the annular projections being arranged in the axial direction (direction of the arrow A). Blocking rings 120a are disposed on the respective outer circumferential surfaces of the annular projections 120 to airtightly block up the spool accommodation space 82 in cooperation with the inward projections 110 (see FIG. 7A).

The spool 80 is displaced in the axial direction of the spool accommodation space 82 (direction of the arrow A) under operation of the solenoid valve 130 disposed in the solenoid valve arrangement space 74. Specifically, the spool 80 is disposed at a first position adjacent to the solenoid valve piston portion 118 when the solenoid valve 130 is de-energized and at a second position adjacent to the restricting member 116 when the solenoid valve 130 is energized. The plurality of annular projections 120 come into contact with different objects (i.e., inward projections 110) in the spool accommodation space 82 as appropriate depending on whether the spool 80 is disposed at the first position or the second position, to thereby partially shut off the flow of the pressurized fluid inside the spool accommodation space 82 in cooperation with the inward projections 110.

When the spool 80 is disposed at the first position, the supply channel 92 and the rod-side communication channel 100 communicate with each other via the spool accommodation space 82, while the head-side discharge channel 94 and the head-side communication channel 98 communicate with each other via the spool accommodation space 82 (see also FIG. 7A). At this moment, one of the inward projections 110 that is positioned closer to the base end than the communication point between the rod-side discharge channel 96 and the spool accommodation space 82 come into contact with the corresponding annular projection 120 on the spool 80. This causes the rod-side discharge channel 96 to be airtightly isolated from the space through which the supply channel 92 and the rod-side communication channel 100 communicate with each other.

On the other hand, when the spool 80 is disposed at the second position, the supply channel 92 and the head-side communication channel 98 communicate with each other via the spool accommodation space 82, while the rod-side discharge channel 96 and the rod-side communication channel 100 communicate with each other via the spool accommodation space 82 (see also FIG. 7B). At this moment, one of the inward projections 110 that is closer to the distal end than the communication point between the head-side discharge channel 94 and the spool accommodation space 82 come into contact with the corresponding annular projection 120 on the spool 80. This causes the head-side discharge channel 94 to be airtightly isolated from the space through which the supply channel 92 and the head-side communication channel 98 communicate with each other.

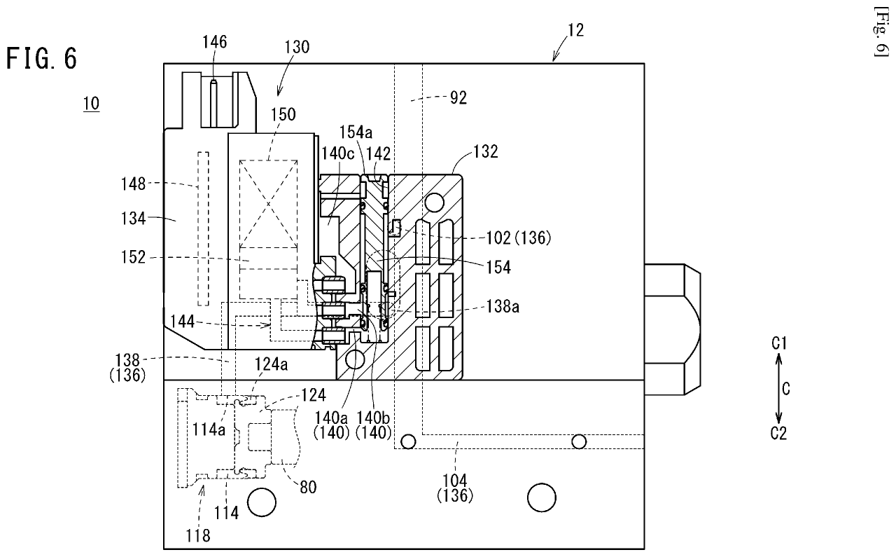

Moreover, as illustrated in FIGS. 5 and 6, regardless of whether the spool 80 is at the first position or the second position, part of the pressurized fluid supplied from the supply port 86 is supplied to the solenoid valve 130 via the first branch channel 102. Furthermore, another part of the pressurized fluid flowing into the spool accommodation space 82 is also supplied to the first pressure chamber 112 via the second branch channel 104.

The solenoid valve 130 is disposed in the cut-off space in the body 12 (solenoid valve arrangement space 74) and secured to the first surface 70a (first wall portion 70) and the intermediate surface 71a of the structural wall 68. As described above, the solenoid valve 130 moves the spool 80 between the first position and the second position inside the spool accommodation space 82. In this embodiment, a pilot operated solenoid valve capable of saving electric power is used as the solenoid valve 130. However, the structure for moving the spool 80 is not limited to such a pilot operated solenoid valve, and a direct acting solenoid valve, for example, may be used as the solenoid valve 130 to move the spool 80.

As illustrated in FIG. 1, the solenoid valve arrangement space 74 is open at the distal end surface 16, the base end surface 18, and the third side surface 24 of the body 12, and is cut off to have such a size that the solenoid valve 130 does not protrude from the second surface 72a of the structural wall 68, the distal end surface 16, the base end surface 18, and the third side surface 24. More specifically, when a virtual outer shape 122 is set (defined) by the most-protruding faces in the respective surfaces (the distal end surface 16, the base end surface 18, and the first, second, third, and fourth side surfaces 20, 22, 24, and 26) of the body 12, the solenoid valve 130 is disposed inside the virtual outer shape 122. In other words, the solenoid valve 130 is integrated with the body 12 without protruding from the surfaces of the rectangular parallelepiped body 12 (virtual outer shape 122).

As illustrated in FIG. 6, the solenoid valve 130 includes a first housing 132 directly connected to the first wall portion 70 of the structural wall 68 and a second housing 134 directly connected to the first housing 132. Moreover, the structural wall 68 of the body 12 is provided with a solenoid valve communication structure 136 communicating with the above-described solenoid valve piston portion 118 and a channel (first housing channel 140) inside the solenoid valve 130 at a position corresponding to the position of the solenoid valve 130.

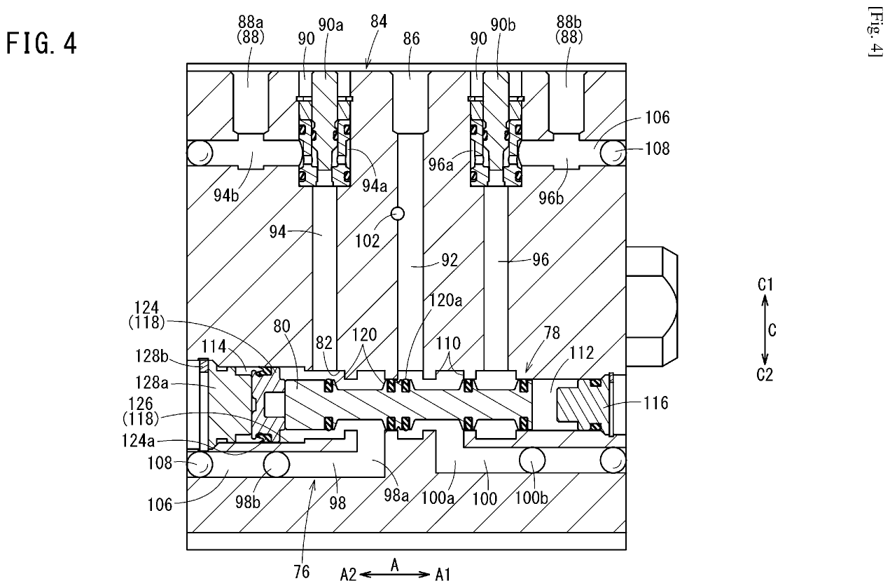

Specifically, as illustrated in FIG. 4, the solenoid valve piston portion 118 includes a pilot piston 124 and a piston accommodation space 126 communicating with the spool accommodation space 82 and in which the pilot piston 124 is movably disposed. The pilot piston 124 is connected to the base end of the spool 80. The pilot piston 124 has, on an outer circumferential surface thereof, a piston packing 124a that is in airtight contact with the inner circumferential surface defining the piston accommodation space 126. That is, the piston accommodation space 126 is partitioned into a part communicating with the spool accommodation space 82 and the second pressure chamber 114 by the pilot piston 124 being accommodated in the piston accommodation space.

The base end (side at which the arrow A2 is pointing) of the second pressure chamber 114 is airtightly closed by a plug member 128a and a locking member 128b. As illustrated in FIG. 6, the second pressure chamber 114 has a second pressure chamber opening 114a communicating with the solenoid valve communication structure 136. The diameters of the pilot piston 124 and the piston accommodation space 126 are set to values sufficiently greater than the diameter of the spool 80. Thus, the pressurized fluid flowing into the second pressure chamber 114 applies pressure greater than the pressure applied to the spool 80 in the spool accommodation space 82 (first pressure chamber 112), to the pilot piston 124.

The solenoid valve communication structure 136 selectively flows pressurized fluid into the first pressure chamber 112 or the second pressure chamber 114. The solenoid valve communication structure 136 includes the first branch channel 102 and the second branch channel 104 as described above, and further includes a second pressure chamber communication channel 138 connecting the second pressure chamber 114 with a solenoid valve opening 138a formed in an attachment surface (surface facing the first wall portion 70) of the first housing 132.

The second branch channel 104 causes pressurized fluid to flow from the spool accommodation space 82 to the first pressure chamber 112 in a steady manner, to thereby push the spool 80 from the first pressure chamber 112 toward the base end. A distal end part (on the side at which the arrow A1 is pointing) of the spool 80 has a smaller cross-sectional area compared with the pilot piston 124, and the spool 80 is disposed at the first position in the spool accommodation space 82.

Pressurized fluid flows from the first branch channel 102 to the second pressure chamber communication channel 138 via the solenoid valve 130. When the solenoid valve 130 is energized, pressurized fluid is allowed to flow into the second pressure chamber 114 and pushes the pilot piston 124 toward the distal end. The pilot piston 124 receives pushing force from the second pressure chamber 114, which is greater than the pushing force from the first pressure chamber 112, whereby the spool 80 is disposed at the second position in the spool accommodation space 82.

Moreover, the first housing channel 140 communicating with the first branch channel 102 and the solenoid valve opening 138a and a manual operator space 142 communicating with the first housing channel 140 are formed inside the first housing 132 of the solenoid valve 130. The second housing 134 has, formed therein, a second housing channel 144, and also has therein a power port 146, a circuit board 148, a coil 150, a movable valve portion 152, and other elements. The power port 146 is located at a position adjacent to the third side surface 24 of the body 12 so as not to protrude from the third side surface 24. The circuit board 148 is electrically connected to a power supply (not illustrated) via the power port 146 and has a function of switching between energization and de-energization of the coil 150 at predetermined timings.

The first housing channel 140 includes a first path 140a connecting the first branch channel 102 with the second housing channel 144 via the manual operator space 142, a second path 140b connecting the second housing channel 144 with the second pressure chamber communication channel 138 via the manual operator space 142, and a discharge path 140c communicating with the outside of the first housing 132.

On the other hand, the second housing channel 144 connects the first path 140a and the second path 140b in the first housing 132, and the movable valve portion 152 is disposed at an intermediate position in the second housing channel 144 so as to be movable back and forth. The movable valve portion 152 includes, for example, a valve element (not illustrated) configured to be displaced under the electromagnetic action of the coil 150 and a diaphragm (not illustrated) supporting the peripheral portion of the valve element and connected to the second housing 134.

When the coil 150 is de-energized, the solenoid valve 130 blocks the communication of the second housing channel 144 by using the movable valve portion 152. This prevents pressurized fluid from flowing into the first path 140a (first branch channel 102), and pressurized fluid led from the second branch channel 104 into the first pressure chamber 112 pushes the spool 80. On the other hand, when the coil 150 is energized, the solenoid valve 130 moves the movable valve portion 152 to establish the communication of the second housing channel 144. As a result, the pressurized fluid is led into the second pressure chamber 114 via the first path 140a, the second housing channel 144, the second path 140b, and the second pressure chamber communication channel 138. The pressurized fluid flowing into the second pressure chamber 114 pushes the pilot piston 124 by greater pushing force than the internal pressure of the first pressure chamber 112 to move the pilot piston 124 toward the distal end. As a result, the pilot piston 124 moves the spool 80 to the second position when the coil 150 is energized.

The manual operator space 142 in the first housing 132 extends in the direction of the arrow C and has an opening at an end portion thereof. A manual operator 154 is disposed inside the manual operator space 142. The manual operator 154 is screw-engaged with a clip structure provided in the manual operator space 142 of the first housing 132, and is thereby capable of being displaced. That is, a user can change the vertical position of the manual operator 154 by manually operating a head portion 154a exposed at the upper end of the manual operator space 142 to manually change the position of the pilot piston 124 from the base end position to the distal end position or vice versa.

The fluid pressure cylinder 10 according to this embodiment is basically configured as above. Next, the operational effects thereof will be described.

As illustrated in FIG. 1, the fluid pressure cylinder 10 is offered as a product with the solenoid valve 130 disposed in the solenoid valve arrangement space 74 of the body 12, and is installed in an installation target by a user. Here, in the body 12 of the fluid pressure cylinder 10, the solenoid valve 130 is disposed inside the virtual outer shape 122 (i.e., the solenoid valve does not protrude from the second surface 72a of the structural wall 68, the distal end surface 16, the base end surface 18, and the third side surface 24). That is, the body 12 does not increase in size although the solenoid valve 130 is disposed inside the fluid pressure cylinder 10. This allows the fluid pressure cylinder 10 to be easily installed in an installation target having a small space (without changing the design of the installation target, for example).

As illustrated in FIGS. 7A and 7B, a joint connected to the pressurized fluid supply device 200 is inserted and secured to the supply port 86 of the fluid pressure cylinder 10. The pressurized fluid supply device 200 supplies pressurized fluid to the supply port 86 of the fluid pressure cylinder 10 at an appropriate supply pressure (supply rate). Moreover, a power source plug (not illustrated) is connected to the power port 146 of the solenoid valve 130 of the fluid pressure cylinder 10 by a user. This enables the solenoid valve 130 to switch between energization and de-energization of the coil 150 under the control of the circuit board 148.

As described above, the fluid pressure cylinder 10 also supplies part of the pressurized fluid that has flowed into the supply port 86, to the solenoid valve 130 via the supply channel 92 and the first branch channel 102. When the coil 150 is de-energized, the solenoid valve 130 blocks the communication of the first housing channel 140 and thereby causes pressurized fluid to flow into the first pressure chamber 112 through the spool accommodation space 82 and the second branch channel 104 and to push the pilot piston 124 toward the base end (toward the base end position). This causes the spool 80 connected with the pilot piston 124 to be disposed at the first position.

As illustrated in FIG. 7A, when the spool 80 is disposed at the first position, the supply channel 92 and the rod-side communication channel 100 communicate with each other via the spool accommodation space 82. Thus, the pressurized fluid supplied to the supply port 86 flows through the supply channel 92, the spool accommodation space 82, and the rod-side communication channel 100 in this order, and is supplied from the rod-side opening 48a to the rod-side cylinder chamber 48 in the cylinder hole 14. The pressurized fluid supplied to the rod-side cylinder chamber 48 applies pushing force such that the piston 30 moves toward the base end.

The pushing force causes the piston 30 and the piston rod 32 of the fluid pressure cylinder 10 to be disposed at the base end side. Here, in a case where the piston 30 is disposed at a position closer to the distal end side than the first position (i.e., in a case where pressurized fluid is in the head-side cylinder chamber 46), pressurized fluid is discharged from the head-side cylinder chamber 46 as the piston 30 moves toward the base end. When the spool 80 is disposed at the first position, the head-side discharge channel 94 and the head-side communication channel 98 communicate with each other via the spool accommodation space 82. Thus, the pressurized fluid in the head-side cylinder chamber 46 flows in the head-side communication channel 98, the spool accommodation space 82, the head-side discharge channel 94, the controller port 90, and the discharge port 88. The pressurized fluid is then discharged from the discharge port 88 to the outside (atmosphere).

The opening of the head-side speed controller 90a in the controller port 90 is set by the user as appropriate such that the discharge rate of the pressurized fluid passing through the head-side speed controller 90a is adjusted during discharge. As a result, the flow rate of pressurized fluid discharged from the head-side cylinder chamber 46, in other words, the speed of the piston 30 moving toward the base end is adjusted.

On the other hand, when the coil 150 is energized, the solenoid valve 130 operates to push the pilot piston 124 toward the distal end using the pressurized fluid supplied from the first branch channel 102. This causes the spool 80 connected to the pilot piston 124 to be disposed at the second position.

As illustrated in FIG. 7B, while the spool 80 is disposed at the second position, the supply channel 92 and the head-side communication channel 98 communicate with each other via the spool accommodation space 82. Thus, the pressurized fluid supplied to the supply port 86 flows through the supply channel 92, the spool accommodation space 82, and the head-side communication channel 98 in this order, and is supplied from the head-side opening 46a to the head-side cylinder chamber 46 in the cylinder hole 14. The pressurized fluid supplied to the head-side cylinder chamber 46 applies pushing force such that the piston 30 moves toward the distal end.

The pushing force causes the piston 30 and the piston rod 32 of the fluid pressure cylinder 10 to be disposed at the distal end side. Here, in a case where the piston 30 is disposed at a position closer to the base end side than the advanced position (i.e., in a case where pressurized fluid is in the rod-side cylinder chamber 48), pressurized fluid is discharged from the rod-side cylinder chamber 48 as the piston 30 moves toward the distal end. When the spool 80 is disposed at the second position, the rod-side discharge channel 96 and the rod-side communication channel 100 communicate with each other via the spool accommodation space 82. Thus, the pressurized fluid in the rod-side cylinder chamber 48 flows in the rod-side opening 48a, the rod-side communication channel 100, the spool accommodation space 82, the rod-side discharge channel 96, the controller port 90, and the rod-side discharge port 88b. The pressurized fluid is then discharged from the rod-side discharge port 88b to the outside (atmosphere).

The opening of the rod-side speed controller 90b in the controller port 90 is set by the user as appropriate such that the discharge rate of the pressurized fluid passing through the rod-side speed controller 90b is adjusted during discharge. As a result, the flow rate of pressurized fluid discharged from the rod-side cylinder chamber 48, in other words, the speed of the piston 30 moving toward the distal end is adjusted.

In this manner, the piston 30 and the piston rod 32 of the fluid pressure cylinder 10 can be moved back and forth at desired speeds by operating the solenoid valve 130 while pressurized fluid is supplied to the supply port 86.

The present invention is not limited in particular to the above-described embodiment, and various modifications can be made thereto without departing from the scope of the present invention. For example, the structures of the channels 76, the channel selector 78, and the solenoid valve communication structure 136 provided on the body 12 may be freely designed as long as the piston 30 can move back and forth.

(Modification)

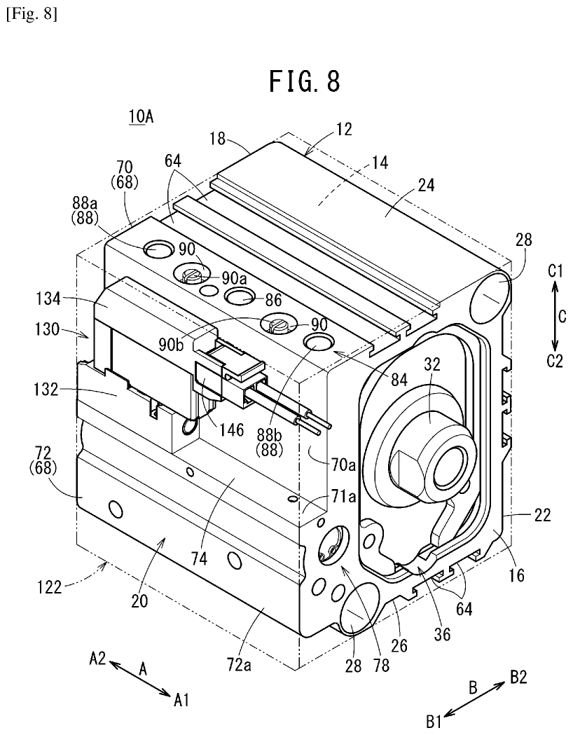

Next, a fluid pressure cylinder 10A according to a modification will be described with reference to FIG. 8. In the description below, the same reference numerals and symbols are used for components having structures or functions identical to those of the components of the above-described embodiment, and the detailed descriptions will be omitted.

The fluid pressure cylinder 10A according to the modification differs from the fluid pressure cylinder 10 in that the solenoid valve 130 attached to the body 12 is rotated by 90° with respect to the solenoid valve 130 of the fluid pressure cylinder 10. That is, the first housing 132 of the solenoid valve 130 is attached to the second wall portion 72 (intermediate surface 71a) of the body 12 and extends in the extension direction of the second wall portion 72 (direction of the arrow A). The second housing 134 is disposed on a side, of the first housing 132, at which the arrow C1 is pointing. The power port 146 of the solenoid valve 130 protrudes in the direction of the arrow A1. Although not specifically illustrated, the coil 150, the movable valve portion 152, and other components disposed inside the second housing 134 are also arranged in the direction of the arrow A.

On the other hand, the channels 76, the channel selector 78, and the solenoid valve communication structure 136 in the body 12 of the fluid pressure cylinder 10A have structures substantially identical to those of the fluid pressure cylinder 10. In this manner, the orientation of the solenoid valve 130 with respect to the body 12 is not particularly limited, and the fluid pressure cylinders 10 and 10A may be designed as appropriate such that the solenoid valve 130 does not protrude from the surfaces (virtual outer shape 122) of the body 12.

The technical scope and the effects that can be understood from the above-described embodiment will now be described below.

The fluid pressure cylinders 10 and 10A include the previously-installed solenoid valve 130 configured to switch between supply and discharge of pressurized fluid to and from the head-side cylinder chamber 46 or the rod-side cylinder chamber 48. Thus, the solenoid valve 130 is not required to be added separately for actual use of the fluid pressure cylinders 10 and 10A. Moreover, since the cylinder hole 14 and the outer edge of the piston 30 of the fluid pressure cylinders 10 and 10A have polygonal shapes, the body 12 can be reduced in size (thickness) while a sufficient area of the piston 30, which is pushed by pressurized fluid, is ensured compared with, for example, a fluid pressure cylinder including a cylinder hole and a piston that have circular shapes when viewed in section. In addition, since the solenoid valve 130 is disposed inside the virtual outer shape 122 of the body 12, the fluid pressure cylinders 10 and 10A do not increase in size as entire systems during use, allowing users to, for example, carry out design for installation in a preferred manner. That is, the fluid pressure cylinders 10 and 10A can achieve significant space-saving and improved usability during use with a simple structure.

The stepped shape of the one surface (the first side surface 20) of the body 12 is formed of the first wall portion 70 and the second wall portion 72 thicker than the first wall portion 70. The first wall portion 70 and the second wall portion 72 include the channels 76 through which the pressurized fluid flows, and the second wall portion 72 includes the channel selector 78 configured to switch the channels 76 through which pressurized fluid flows. Thus, the fluid pressure cylinders 10 and 10A can easily switch between selective supply of pressurized fluid to the head-side cylinder chamber 46 or the rod-side cylinder chamber 48 and selective discharge of the pressurized fluid from the head-side cylinder chamber 46 or the rod-side cylinder chamber 48. Moreover, since the fluid pressure cylinders 10 and 10A include the channel selector 78 formed in the second wall portion 72, the formation of the channel selector 78 does not cause an increase in the size of the body 12. This leads to a further reduction in the size of the fluid pressure cylinders 10 and 10A.

The channel selector 78 includes the spool 80 configured to be displaced under operation of the solenoid valve 130 and the spool accommodation space 82 in which the spool 80 is movably accommodated and with which the channels 76 communicate. The spool accommodation space 82 extends in the longitudinal direction of the second wall portion 72. Thus, the fluid pressure cylinders 10 and 10A can smoothly switch the channels 76 through which pressurized fluid flows, based on the movement of the spool 80 using the solenoid valve 130. In particular, since the spool accommodation space 82 extends in the longitudinal direction of the second wall portion 72, a sufficient space allowing the spool 80 to be displaced therein is ensured.

The channels 76 include the supply channel 92 through which the pressurized fluid is supplied into the spool accommodation space 82, the head-side communication channel 98 configured to connect the spool accommodation space 82 and the head-side cylinder chamber 46, the rod-side communication channel 100 configured to connect the spool accommodation space 82 and the rod-side cylinder chamber 48, the head-side discharge channel 94 through which the pressurized fluid in the head-side cylinder chamber 46 is discharged via the spool accommodation space 82; and the rod-side discharge channel 96 through which the pressurized fluid in the rod-side cylinder chamber 48 is discharged via the spool accommodation space 82. With this configuration, the fluid pressure cylinders 10 and 10A allow the pressurized fluid to flow from the supply channel 92 to the head-side cylinder chamber 46 or the rod-side cylinder chamber 48, from the head-side cylinder chamber 46 to the head-side discharge channel 94, and from the rod-side cylinder chamber 48 to the rod-side discharge channel 96 via the spool accommodation space 82. In addition, the channels 76 can be appropriately switched in the spool accommodation space 82 in accordance with the position of the spool 80.

The supply channel 92 communicates with the supply port 86 formed in a side surface (third side surface 24) orthogonal to the one surface (first side surface 20), the head-side discharge channel 94 communicates with the head-side discharge port 88a formed in the side surface, the rod-side discharge channel 96 communicates with the rod-side discharge port 88b formed in the side surface, the head-side speed controller 90a exposed at the side surface is disposed at an intermediate position in the head-side discharge channel 94, the head-side speed controller being configured to adjust discharge rate of the pressurized fluid, and the rod-side speed controller 90b exposed at the side surface is disposed at an intermediate position in the rod-side discharge channel 96, the rod-side speed controller being configured to adjust the discharge rate of the pressurized fluid. The fluid pressure cylinders 10 and 10A include the head-side speed controller 90a in the head-side discharge channel 94 and the rod-side speed controller 90b in the rod-side discharge channel 96, thereby allowing a user to adjust the discharge speed of the pressurized fluid. Thus, the movement speed of the piston 30 in the fluid pressure cylinders 10 and 10A can be set in a preferred manner.

In the fluid pressure cylinder 10, the solenoid valve 130 includes the power port 146 through which electric power is supplied to the solenoid valve 130, and the extension direction of the power port 146 is identical to the extension direction of the supply port 86. Since the extension direction of the power port 146 and the extension direction of the supply port 86 are identical, the power plug connected to the power port 146 and the joint connected to the supply port 86 extend in the same direction. Thus, the surfaces except for the surface along which the plug and the joint extend are prevented from largely expanding outward from the virtual outer shape 122 during use of the fluid pressure cylinder 10.

The second wall portion 72 is formed so as to be continuous to one side of the one surface (first side surface 20) and is connected to the entire one side in the extension direction of the one side. With this configuration, the second wall portion 72 of the fluid pressure cylinders 10 and 10A is disposed closer to the one side of the first side surface 20, and accordingly the volume of the solenoid valve arrangement space 74 (cut-off space) in which the solenoid valve 130 is disposed increases. As a result, the solenoid valve 130 is suitably disposed inside the solenoid valve arrangement space 74 without protruding outward from the virtual outer shape 122.

In the fluid pressure cylinders 10 and 10A, the second wall portion 72 extends parallel to the moving direction of the piston 30. Owing thereto, the channel selector 78 can be disposed in the second wall portion 72 without blocking the movement of the piston 30, and the second wall portion 72 is thus prevented from increasing in thickness. As a result, a reduction in the size of the body 12 is further facilitated.

The solenoid valve 130 is a pilot operated solenoid valve communicating with the channels 76 and receiving the pressurized fluid supplied from the channels 76 to operate the channel selector 78 based on the pressurized fluid. Use of the pilot operated solenoid valve allows the fluid pressure cylinders 10 and 10A to displace the spool 80 in a stable manner while saving electric power for driving the solenoid valve 130.

The cylinder hole 14 further includes the inclined inner circumferential surface (the fifth inner circumferential surface 14e and the sixth inner circumferential surface 140 inclined with respect to the surfaces when viewed in section orthogonal to the extension direction of the cylinder hole 14, and the body 12 includes the fastener hole 28 configured to be used to secure the body 12 to an installation target, at a position adjacent to the inclined inner circumferential surface. Since the fluid pressure cylinders 10 and 10A include the fastener holes 28 at the positions adjacent to the fifth inner circumferential surface 14e and the sixth inner circumferential surface 14f, the fluid pressure cylinders 10 and 10A can be attached to the installation target without an increase in the size of the body 12.

1. A fluid pressure cylinder comprising:
a body having a rectangular parallelepiped shape with a cylinder hole;
a piston movably accommodated in the cylinder hole; and
a piston rod secured to the piston, wherein:
when viewed in section orthogonal to an extension direction of the cylinder hole, the cylinder hole has a polygonal shape including inner circumferential surfaces parallel to a plurality of surfaces constituting the body;
the piston has a polygonal outer edge having a shape corresponding to a shape of the cylinder hole accommodating the piston and partitions the cylinder hole into a head-side cylinder chamber and a rod-side cylinder chamber;
the body is cut off so that one surface of the plurality of surfaces constituting the body has a stepped shape, and a solenoid valve configured to switch between supply of pressurized fluid to the headside cylinder chamber or the rod-side cylinder chamber and discharge of the pressurized fluid from the head-side cylinder chamber or the rodside cylinder chamber is disposed in a space formed by cutting off the body; and
the solenoid valve is disposed inside a virtual outer shape defined by most-protruding faces in the respective surfaces.

2. The fluid pressure cylinder according to claim 1, wherein:
the stepped shape of the one surface of the body is formed of a first wall portion and a second wall portion thicker than the first wall portion;
the first wall portion and the second wall portion include channels through which the pressurized fluid flows; and
the second wall portion includes a channel selector configured to switch the channels through which the pressurized fluid flows.

3. The fluid pressure cylinder according to claim 2, wherein:
the channel selector includes a spool configured to be displaced under operation of the solenoid valve, and a spool accommodation space in which the spool is movably accommodated and with which the channels communicate; and
the spool accommodation space extends in a longitudinal direction of the second wall portion.

4. The fluid pressure cylinder according to claim 3, wherein:
the channels include:
a supply channel through which the pressurized fluid is supplied into the spool accommodation space;
a head-side communication channel configured to connect the spool accommodation space and the head-side cylinder chamber;
a rod-side communication channel configured to connect the spool accommodation space and the rod-side cylinder chamber;
a head-side discharge channel through which the pressurized fluid in the head-side cylinder chamber is discharged via the spool accommodation space; and
a rod-side discharge channel through which the pressurized fluid in the rod-side cylinder chamber is discharged via the spool accommodation space.

5. The fluid pressure cylinder according to claim 4, wherein:
the supply channel communicates with a supply port formed in a side surface orthogonal to the one surface;
the head-side discharge channel communicates with a head-side discharge port formed in the side surface;
the rod-side discharge channel communicates with a rod-side discharge port formed in the side surface;
a head-side speed controller exposed at the side surface is disposed at an intermediate position in the head-side discharge channel, the head-side speed controller being configured to adjust discharge rate of the pressurized fluid; and
a rod-side speed controller exposed at the side surface is disposed at an intermediate position in the rod-side discharge channel, the rodside speed controller being configured to adjust the discharge rate of the pressurized fluid.

6. The fluid pressure cylinder according to claim 5, wherein:
the solenoid valve includes a power port through which electric power is supplied to the solenoid valve; and
an extension direction of the power port is identical to an extension direction of the supply port.

7. The fluid pressure cylinder according to claim 2, wherein the second wall portion is formed so as to be continuous to one side of the one surface and is connected to an entirety of the one side in an extension direction of the one side.

8. The fluid pressure cylinder according to claim 7, wherein the second wall portion extends parallel to a moving direction of the piston.

9. The fluid pressure cylinder according to claim 2, wherein the solenoid valve is a pilot operated solenoid valve communicating with the channels and receiving the pressurized fluid supplied from the channels to operate the channel selector based on the pressurized fluid.

10. The fluid pressure cylinder according to claim 1, wherein:
the cylinder hole further includes an inclined inner circumferential surface inclined with respect to the surfaces when viewed in section orthogonal to the extension direction of the cylinder hole; and
the body includes a fastener hole configured to be used to secure the body to an installation target, at a position adjacent to the inclined inner circumferential surface.
